(19) United States
(12) Patent Application Publication
(10) Pub. No.: US 2015/0160141 A1
(43) Pub. Date: Jun. 11, 2015

(54) X-RAY APPARATUS AND X-RAY MEASUREMENT METHOD

(71) Applicant: CANON KABUSHIKI KAISHA, Tokyo (JP)

(72) Inventors: Taihei Mukaide, Yokohama-shi (JP); Yuto Niinuma, Kawasaki-shi (JP)

(21) Appl. No.: 14/407,048

(22) PCT Filed: Jun. 5, 2013
(86) PCT No.: PCT/JP2013/003531

§ 371 Date: Dec. 10, 2014

(30) Foreign Application Priority Data
Jun. 15, 2012 (JP) 2012-135443

(51) Int. Cl. G01N 23/04; G21K 1/10; G21K 1/04

(52) U.S. Cl. CPC G01N 23/04; G21K 1/04; G21K 1/10; G21K 2207/005

(57) ABSTRACT

The invention provides an X-ray apparatus and an X-ray measurement method that can increase sensitivity to a positional shift of an X-ray as compared with related art.

An X-ray apparatus includes a splitting element configured to spatially split an X-ray from an X-ray generator and form an X-ray beam; a detector configured to detect an intensity of the X-ray beam, which has been split by the splitting element and has passed through a detection object, the detector including a plurality of pixels; and an absorbing element arranged at a boundary of two pixels from among the plurality of pixels included in the detector and configured to absorb part of the X-ray beam. The X-ray beam is configured to discretely irradiate the two pixels of the detector.

### TECHNICAL FIELD

The present invention relates to an X-ray apparatus using an X-ray and to an X-ray measurement method.

### BACKGROUND ART

A nondestructive inspection method using radiations is used in a wide variety of fields from industrial use to medical use. For example, X-rays, which are one type of radiations, are electromagnetic waves with wavelengths in a range from about 10⁻¹² to 10⁻⁸ m. From among the X-rays, X-rays with high energy (in a range from about 2 to 100 keV) are called hard X-rays, and X-rays with low energy (in a range from about 0.1 to 2 keV) are called soft X-rays.

An absorption contrast method using a difference in absorptivity of an X-ray is in practical use for, for example, an internal crack inspection for a steel material, or a hand baggage inspection in a security field.

An X-ray phase contrast method that detects a change in phase of an X-ray in accordance with a detection object is effective for a detection object having difficulty in formation of contrast through absorption of an X-ray (for example, a detection object with a low density). Application of the X-ray phase contrast method to imaging of a phase separation structure of a polymer material and to a medical care is being studied.

An X-ray phase contrast method described in PTL 1 is a method of causing a split X-ray (an X-ray beam) to be incident on a detection object, and measuring a refraction angle of the X-ray beam which has passed through the detection object.

FIG. 9 is a schematic illustration of an apparatus described in PTL 1. An X-ray generated from an X-ray source 901 is spatially split by a splitting element 902. Each spatially split X-ray beam passes through a detection object 903, and then irradiates an X-ray detector 904.

FIG. 10 is a schematic illustration of the X-ray detector 904. The X-ray detector 904 includes a plurality of pixels 1001. For example, a reference X-ray beam 1002 split by the splitting element 902 (an X-ray beam when the detection object 903 is not arranged in an optical path) is discretely emitted in X and Y directions.

The X-ray detector 904 detects the intensity of the emitted X-ray beam at each pixel. An X-ray beam 1003 indicates an X-ray beam that is refracted when passing through the detection object 903. With a refraction effect, the incidence position of the X-ray beam 1003 to the X-ray detector 904 is changed with respect to the reference X-ray beam 1002. Also, with an absorption effect, the integrated intensity of the X-ray beam 1003 becomes smaller than the integrated intensity of the reference X-ray beam 1002.

The X-ray transmissivity of the detection object 903 can be obtained by using a value of the sum of the X-ray detection intensities at the pixels irradiated with the reference X-ray beam 1002 and a value of the sum of the X-ray detection intensities at the pixels irradiated with the X-ray beam 1003. Since an image is formed for a change in intensity of an X-ray, an absorption contrast image of the detection object 903 can be obtained.

Also, a position change amounts deltaX and deltaY of the X-ray beam 1003 in the X and Y directions can be obtained through comparison between the center of gravity of the X-ray beam 1003 intensity and the center of gravity of the reference X-ray beam 1002 intensity. As described above, information corresponding to a change in phase of the X-ray beam according to the detection object 903 can be acquired by using the change in center of gravity position of the X-ray beam. Also, if an image of the change in center of gravity position of the X-ray beam is formed, an image of phase information of the X-ray (a phase contrast image) according to the detection object 903 can be acquired. However, higher sensitivity may be required for the positional shift of the X-ray beam.

### CITATION LIST

### Patent Literature

PTL 1: U.S. Pat. No. 5,802,137

### SUMMARY OF INVENTION

### Technical Problem

The present invention provides an X-ray apparatus and an X-ray measurement method that can increase sensitivity to a positional shift of an X-ray beam, as compared with the method described in PTL 1.

### Solution to Problem

An X-ray apparatus according to an aspect of the invention includes a splitting element configured to spatially split an X-ray from an X-ray generator and form an X-ray beam; a detector configured to detect an intensity of the X-ray beam, which has been split by the splitting element and has passed through a detection object, the detector including a plurality of pixels; and an absorbing element arranged at a boundary of two pixels from among the plurality of pixels included in the detector and configured to absorb part of the X-ray beam. The X-ray beam is configured to discretely irradiate the two pixels of the detector.

Further features of the present invention will become apparent from the following description of exemplary embodiments with reference to the attached drawings.

### BRIEF DESCRIPTION OF DRAWINGS

FIG. 1 is an illustration explaining an apparatus configuration according to an embodiment.

FIG. 2 is an illustration explaining an absorber according to the embodiment.

FIG. 3 is an illustration explaining another absorber according to the embodiment.

FIG. 4 is an illustration explaining the relationship between the detection intensity ratio and the position change amount of an X-ray.

FIG. 5 is an illustration explaining an absorber according to Example 1.

FIG. 6 is an illustration explaining the relationship between the detection intensity ratio and the position change amount of an X-ray according to Example 1.

FIG. 7 is an illustration explaining a line profile of an edge portion of a phase contrast image of polystyrene according to Example 1.

FIG. 8 is an illustration explaining an absorber according to Example 2.

FIG. 9 is an illustration explaining an apparatus described in PTL 1.

FIG. 10 is an illustration explaining a detector in the apparatus described in PTL 1.

### DESCRIPTION OF EMBODIMENT

In an embodiment of the invention, position change information of an X-ray caused by the refraction effect of the X-ray according to a detection object is acquired, by using a splitting element that spatially splits an X-ray generated by an X-ray generator and forms X-ray beams, and an absorber that absorbs part of the X-ray beam. In this case, each X-ray beam split by the splitting element irradiates at least two pixels of a detector. Also, the absorber is arranged in a region that contains the boundary of at least two pixels from among a plurality of pixels included in the detector, and absorbs part of the X-ray beams (an X-ray which is incident on the absorber from among the X-ray that forms the X-ray beam). It is to be noted that absorbing part of the X-ray beam includes not only absorbing part of the X-ray that forms the X-ray beam, but also absorbing part of light generated when the X-ray that forms the X-ray beam is emitted. That is, if the detector includes a scintillator, the absorber may be arranged between the scintillator and the pixels, and the absorber may absorb part of the X-ray beam by absorbing part of light from the scintillator.

Further, the X-ray apparatus includes an arithmetic unit that acquires phase information of the detection object by using intensity information of each pixel irradiated with the X-ray beam part of which is absorbed by the absorber. In this specification, the “phase information” includes information obtained by differentiating a change in phase of an X-ray according to a detection object (differential phase information), and information of the change in phase of the X-ray according to the detection object corresponding to information obtained by integrating the differential phase information. Also, the “phase contrast image” is a concept including a differential phase contrast image that is an image based on the differential phase information, and a phase contrast image that is obtained by integrating the differential phase contrast image. A specific embodiment is described below.

### Basic Configuration of Apparatus

According to an embodiment, a configuration example of an X-ray apparatus that obtains a phase contrast image from a change in phase of an X-ray, and an X-ray measurement method are described.

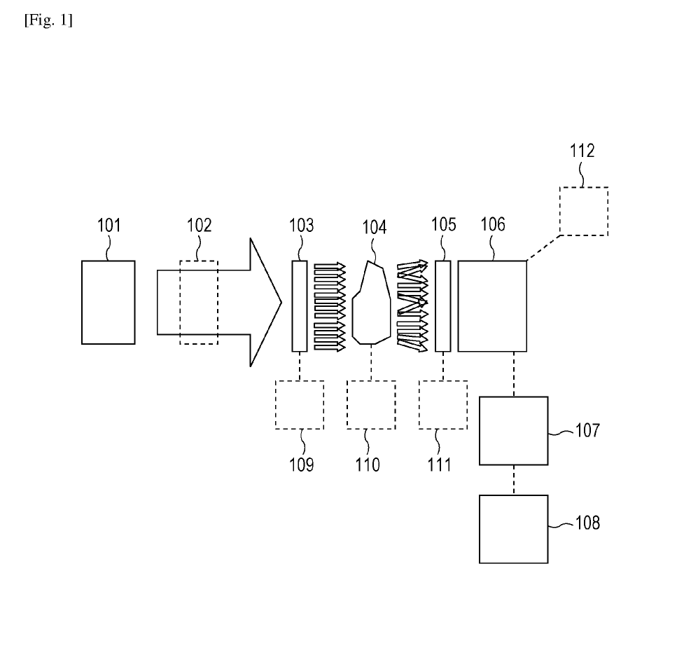

FIG. 1 shows a configuration diagram of an X-ray apparatus according to this embodiment. An X-ray generated by an X-ray source 101, which serves as an X-ray generator, is split into linear beams by a splitting element 103. The splitting element 103 spatially splits the X-ray from the X-ray source, and forms a plurality of X-ray beams. For example, the splitting element 103 may be a slit array having lines and spaces. Alternatively, the splitting element 103 may be two-dimensional slits that are split in a direction orthogonal to a period direction of slits, or a pin-hole array (in which circular openings are two-dimensionally arrayed). In the case of the pin-hole array, position change amounts in at least two directions can be obtained.

The slits or pin holes may penetrate through a substrate of the splitting element, or may not penetrate through the substrate of the splitting element. If the slits or pin holes do not penetrate through the substrate, the substrate of the splitting element may use an X-ray filter material. For example, the material of the splitting element 103 may be selected from Pt, Au, Pb, Ta, and W with a high X-ray absorptivity. Alternatively, the material of the splitting element 103 may be a compound of the above-listed materials.

The X-ray forming the X-ray beam spatially split by the splitting element 103 is changed in phase and refracted by a detection object 104. Also, part of the X-ray forming the X-ray beam is absorbed by the detection object 104. The X-ray beam which has passed through the detection object is incident on an absorber 105. As described above, instead of the X-ray beam, the light that is generated from the scintillator when the X-ray beam is incident thereon may be incident on the absorber.

A detector 106 detects the intensity of the X-ray after the part of the X-ray is absorbed by the absorber 105. An arithmetic unit 107 performs numerical processing on information relating to the X-ray obtained by the detector 106. The information is output to a display 108 such as a monitor.

The detection object 104 may be a human body, a living body, an inorganic material, an inorganic-organic composite material.

Also, moving mechanisms 109, 110, 111, and 112 such as stepping motors that move the splitting element 103, the detection object 104, the absorber 105, and the detector 106 may be additionally provided. For example, if the moving mechanism 110 is provided, the detection object 104 can be properly moved. Accordingly, an image of a specific portion of the detection object 104 can be obtained. Since the splitting element 103 causes the X-ray to discretely irradiate the detection object 104, information of the portion of the detection object 104 not irradiated with the X-ray cannot be obtained. Therefore, if the detection object 104 is measured while being scanned with respect to the X-ray, information of the entire detection object 104 can be obtained. As the result, resolution of an output image can be increased.

The detector 106 includes a plurality of pixels, and may be any of various X-ray detectors regardless of indirect-conversion type or direct-conversion type. For example, the detector 106 may be selected from an X-ray CCD camera, an indirect-conversion flat panel detector, and a direct-conversion flat panel detector. To acquire a position change amount of an X-ray beam in two directions or to ensure a region (an imaging area) for acquiring information of a detection object, a two-dimensional X-ray detector is desirably used.

The detector 106 may be arranged closely to the absorber 105, or may be arranged at a constant distance from the absorber 105. Alternatively, the absorber 105 and the detector 106 may be integrally formed, or an absorber may be provided between the scintillator included in the detector and the pixels.

If a monochromatic X-ray is used, a monochromatic converter 102 may be arranged between the X-ray source 101 and the splitting element 103. The monochromatic converter 102 may be a monochromator combined with slits, or an X-ray multilayer mirror.

### Absorber 105

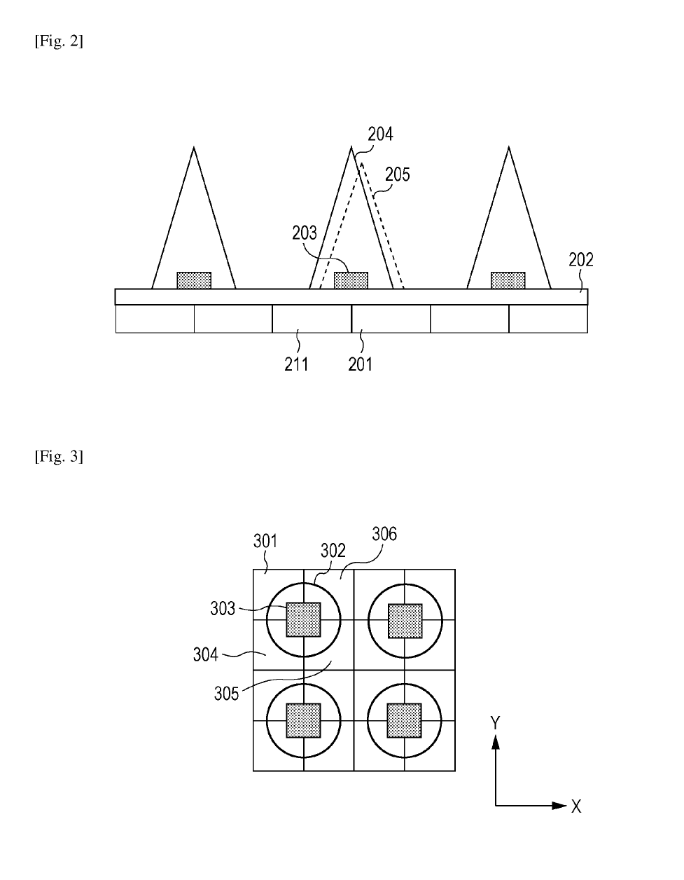

Next, the absorber 105 according to this embodiment is further described with reference to FIG. 2. FIG. 2 shows an example in which the absorber 105 contacts the detector 106.

The detector 106 includes a plurality of pixels 201 and 211, and an X-ray conversion member 202 provided on the pixels 201 and 211. If the indirect-conversion detector is employed, the X-ray conversion member 202 corresponds to the scintillator. If the direct-conversion detector is employed, the X-ray conversion member 202 corresponds to a photoelectric converter. An absorbing element 203 is provided on the boundary of two pixels (the pixel 201 and the pixel 211) (at a position located upstream of the boundary of the two pixels).

The absorber 105 includes a plurality of the absorbing elements 203, and is set so that each absorbing element 203 is included in an irradiation region with the X-ray beam 204 (i.e., part of the X-ray beam 204 is incident on the absorbing element 203). For example, if the splitting element 103 has a slit shape, the absorbing element 203 has a rectangular shape corresponding to the shape of the splitting element 103. Alternatively, for example, as shown in FIG. 3, if a splitting element with a shape in which openings are arrayed in two directions is used, an absorber having a shape in which absorbing elements 303 are arrayed in two directions is used so that each absorbing element 303 is included within an irradiation region with an X-ray beam 302. If the splitting element having the shape in which the openings are arrayed in the two directions is used, the absorbing elements 303 may each have a quadrangular prism shape, and may be arranged on the boundaries of pixels 301, 304, 305, and 306. The absorbing element 303 may be alternatively polygonal, cylindrical, pyramid-like, or conical. As described, if the openings of the splitting element are arrayed in the two directions, the position change amounts of the X-ray beam in the two directions can be acquired. Accordingly, the phase information in the two directions and the phase contrast image can be acquired.

If the absorber 105 is arranged at a distance from the detector 106, the period of the absorbing elements 203 takes into account the magnification with which the absorbing elements 203 are projected on the detector 106. For example, the period of the absorbing elements is designed so as to correspond to the period of two pixels of the detector when the absorbing elements are projected on the detector.

A material of each absorbing element 203 suitable for a formation method may be selected. However, to obtain a structure that is easily processed and has a low aspect, a heavy element with a high X-ray absorptivity, such as Au, may be used.

The absorbing element 203 may absorb the whole emitted X-ray or may transmit part of the X-ray. For example, the transmissivity may be 10% or less, or preferably 5% or less. The absorbing element 203 may be formed on a substrate, or may be embedded in a material with a lower X-ray absorptivity than that of the absorbing element 203. Alternatively, if the absorber is provided between the scintillator and the pixels included in the detector, the absorbing element 203 may be embedded in the X-ray conversion member 202.

In FIG. 2, an X-ray beam 205 indicates an X-ray beam when the detection object 104 is arranged in the optical path of the X-ray. The X-ray, which has passed through the detection object, is refracted, and hence the irradiation position of the X-ray beam on the detector 106 is changed. Also, since the X-ray is absorbed by the detection object 104, the intensity of the X-ray beam detected by the detector is decreased. Owing to this, the position change amount of the X-ray beam can be expected from the detection intensity ratio of each pixel 201, 211 that is irradiated with the X-ray beam.

For example, if it is assumed that the pixel 211 at the left of the pixel irradiated with the X-ray beam 204 has an intensity I₁ and the pixel 201 at the right of the pixel irradiated with the X-ray beam 204 has an intensity Iᵣ, the position change amount of the X-ray beam 204 can be estimated by using a value v shown in Expression (1).

$$\begin{matrix}[ Math . 1 ] & \\ V = \frac{{I}_{l} - {I}_{r}}{{I}_{l} + {I}_{r}} & ( 1 )\end{matrix}$$

In this case, to eliminate the influence by the absorption of the X-ray, the difference between I₁ and Iᵣ is divided by the sum of I₁ and Iᵣ.

Also, the absorption amount of the X-ray by the detection object can be obtained by the sum of I₁ and Iᵣ of the X-ray beam 204, which has not passed through the detection object, and the sum of I₁ and Iᵣ of the X-ray beam 205, which has passed through the detection object. Also, regarding the absorption contrast image, the sum of I₁ and Iᵣ of the X-ray beam 205, which has passed through the detection object, may be calculated and the calculated value may serve as a pixel value of an output image. Alternatively, the average value obtained by dividing the sum of I₁ and Iᵣ by two may serve as the pixel value of the output image. Other calculation methods relating to the sum may be occasionally expressed as “based on the sum.”

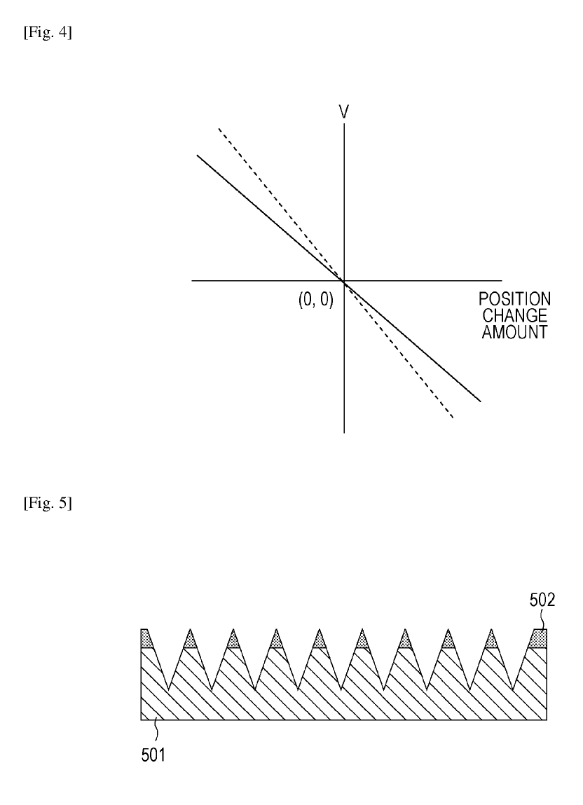

In general, if the position change amount of the X-ray beam 204 is very small, the position change amount and the value v in Expression (1) have the linear relationship as indicated by a solid line in FIG. 4. If the phase information is obtained by using the arithmetic unit 107 and calculating the value v in Expression (1), in order to increase the sensitivity, the inclination of the straight line has to be increased as indicated by a dotted line in FIG. 4.

In general, the X-ray beam 204 has a higher intensity at a center portion, and the intensity symmetrically attenuates from the center toward a periphery portion. The center portion of the X-ray beam has a small gradient in the intensity distribution of the X-ray beam as compared with the periphery portion. Owing to this, in this embodiment, by decreasing the contribution of the X-ray around the center portion of the X-ray beam, the inclination of the relationship between the position change amount and the value v in Expression (1) is increased.

If the above-described absorber 105 is provided, since the absorbing element is provided on the boundary of the two pixels 201 and 211, a region with a low transmissivity can be provided. Accordingly, the contribution of the X-ray around the center portion of the X-ray beam can be decreased, and the inclination of the straight line can be increased. As the result, the X-ray apparatus can increase the sensitivity of the phase information, and can increase the image quality of the phase contrast image.

Also, in order to decrease the contribution of the X-ray around the center portion of the X-ray beam, the absorbing element 203 may be arranged at the position at which the X-ray around the center portion of the X-ray beam 204 is irradiated.

This arrangement can be provided if the two pixels (the pixel 201 and the pixel 211) each have a region that is not provided with the absorbing element and if the region not provided with the absorbing element is irradiated with the X-ray. Also, regardless of the intensity distribution of the X-ray beam, (even if an X-ray beam having an intensity that does not symmetrically attenuate from the center toward the periphery is used,) the absorbing element 203 is desirably arranged so that the distance between the center of the absorbing element 203 and the center of the intensity of the X-ray beam is decreased. The center of the intensity represents the center of the intensity distribution of the X-ray in the irradiation region with the X-ray beam, that is, the peak of the intensity of the X-ray. Also, the center of the absorbing element is the center of gravity of the absorbing element when the absorbing element is viewed from the X-ray generator (the absorbing element in top view). If the shape of the absorbing element is circular, the center of the absorbing element is the center of the circle. If the shape of the absorbing element is rectangular, the center of the absorbing element is an intersection point of the diagonal lines. The center of the absorbing element 203 is desirably arranged at the center of the intensity of the X-ray beam 204.

### Example 1

Example 1 shows an example in which an absorbing element fabricated by cutting was used.

This example uses the X-ray apparatus shown in FIG. 1.

The X-ray source 101 employed an X-ray generation device with a rotating target that was a tungsten target. The splitting element 103 is a slit array in which a tungsten with a thickness of 500 micrometers has slits with a slit width of 50 micrometers arranged at a pitch of 125 micrometers.

FIG. 5 shows the absorber 105. The absorber 105 was fabricated by cutting a member in which an aluminum substrate 501 with a thickness of 1 mm was gold-plated. An absorbing element 502 has a structure in which gold triangular prisms each having a bottom length of 30 micrometers and a height of 15 micrometers are periodically arranged at a pitch of 190 micrometers. The aluminum substrate 501 has a low absorptivity with respect to the X-ray. Accordingly, the aluminum substrate 501 does not function as the absorbing element, and has a negligible difference in absorptivity when the thickness of the aluminum substrate 501 varies.

The detector 106 employed an indirect-conversion flat panel detector with a pixel size of 100×100 micrometers. By using the moving mechanisms 109, 110, 111, and 112, arrangement was made so that the detector 106 was irradiated with the X-ray split by the splitting element 103, on the pixel boundary. The period of the X-ray beam at the detector 106 was adjusted to be 200 micrometers. Similarly, the absorber 105 was adjusted so that the vertex of each triangular prism was arranged at the center of the X-ray beam and the projection period on the detector 106 was 200 micrometers.

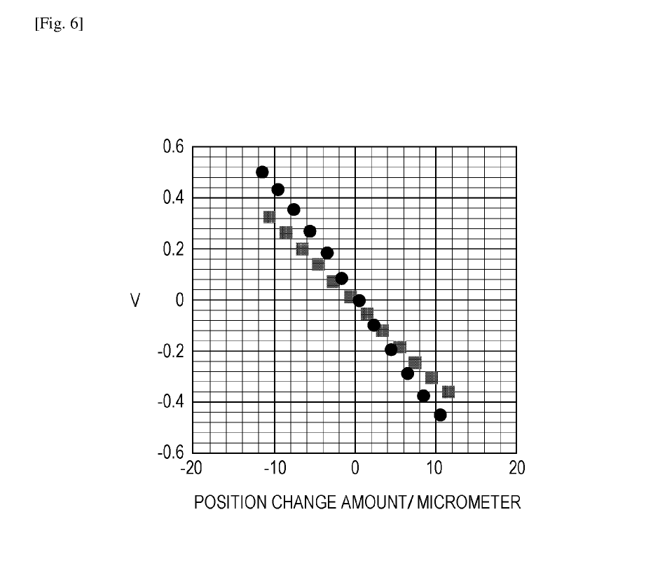

FIG. 6 shows the results of the measurement of the value v with respect to the position change amount of the X-ray by measuring the detection intensity of each pixel of the detector 106 while the splitting element 103 is moved. In FIG. 6, data plotted by black squares is the result without the absorber 105. In contrast, data plotted by black circles is the result with the absorber 105. As shown in the drawing, if the absorber 105 is provided, it is found that the change in the value v with respect to the position change amount of the X-ray is increased.

The detection object 104 employed polystyrene with a diameter of 1 mm. The value v in Expression (1) was obtained by using the arithmetic unit 107, by using the value of the intensity detected at each pixel of the detector 106, and the value v served as the phase information of the detection object. Also, by using the value v as the pixel value, the phase contrast image was acquired.

Also, the absorption information of the detection object was obtained by using the sum of the detection intensities of the pixels, and the absorption information served as the pixel value. Hence, the absorption contrast image was obtained. The obtained image was displayed on a PC monitor that served as the display 108.

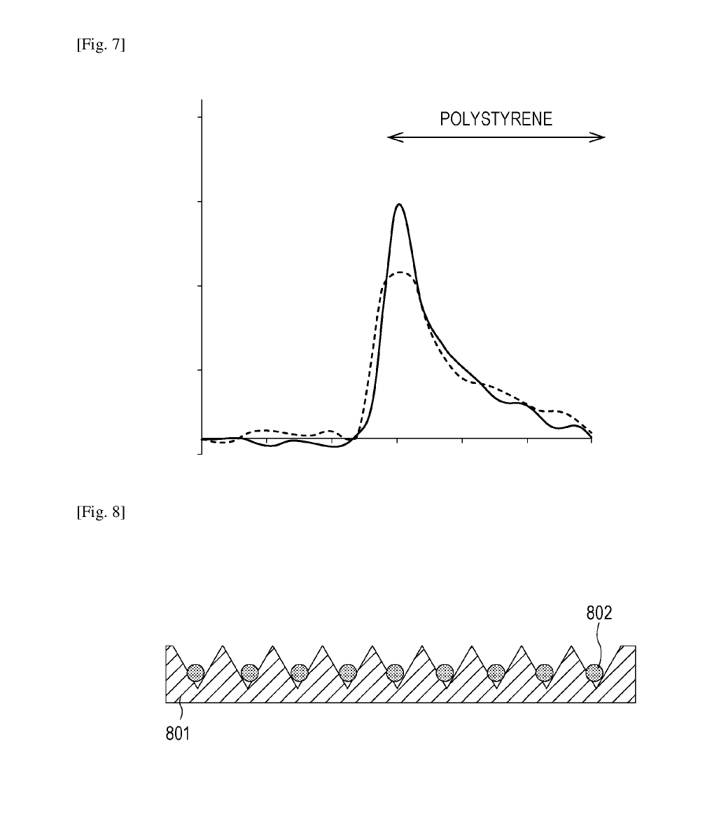

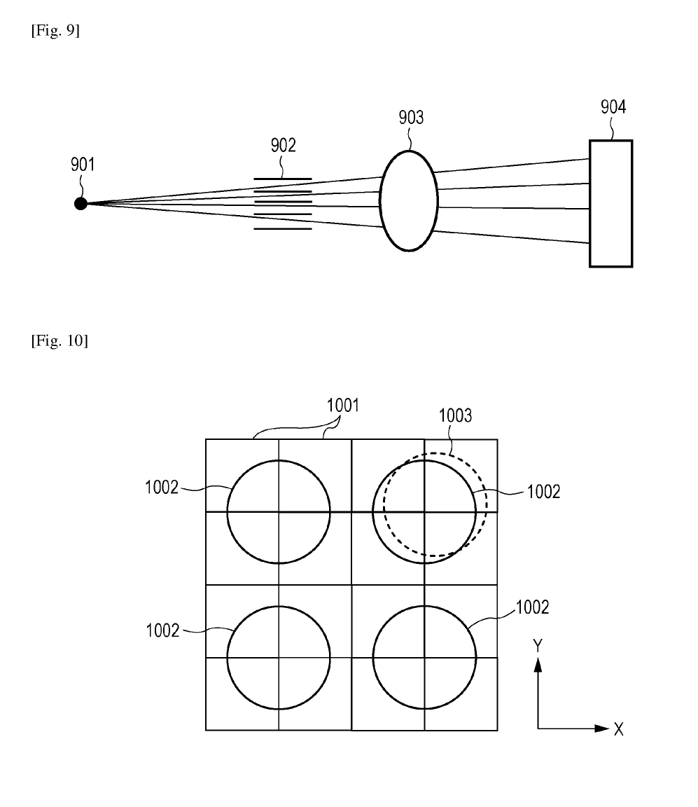

FIG. 7 shows a line profile at an edge portion of a phase contrast image of a polystyrene ball. The profile indicated by a dotted line is the experiment result without the absorber 105. In contrast, the profile indicated by a solid line is the experiment result with the absorber 105. If the absorber 105 is provided, it is found that the contrast is increased.

### Example 2

Example 2 shows an example in which wires are arranged at equal intervals as the absorbing elements.

The basic apparatus configuration of Example 2 is similar to that of Example 1.

However, an aluminum sheet with a thickness of 0.6 mm was arranged as a filter between the X-ray source 101 and the splitting element 103. FIG. 8 shows a schematic illustration of the absorber 105. A substrate 801 is configured such that an acrylic sheet has V-grooves fabricated by die molding and the V-grooves have a pitch of 190 micrometers. An absorbing element 802 is bonded to the grooves of the substrate 801 by a molybdenum wire with a diameter of 50 micrometers.

The detector 106 employed an indirect-conversion flat panel detector with a pixel size of 100×100 micrometers. By using the moving mechanisms 109, 110, 111, and 112, arrangement was made so that the detector 106 was irradiated with the X-ray split by the splitting element 103, on the pixel boundary with a period of 200 micrometers. With this configuration, measurement similar to that of Example 1 was executed and a phase contrast image with high sensitivity could be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-135443, filed Jun. 15, 2012, which is hereby incorporated by reference herein in its entirety.

### REFERENCE SIGNS LIST

101 X-ray source
102 monochromatic converter
103 splitting element
104 detection object
105 absorber
106 detector
107 arithmetic unit
108 display

1. An X-ray apparatus, comprising:
a detector configured to receive a plurality of X-ray beams being discretely incident thereon and detect intensities of the X-ray beams, have passed through a detection object, the detector including a plurality of pixels; and
a plurality of absorbing elements each being arranged at a boundary of two pixels from among the plurality of pixels included in the detector and configured to absorb part of the X-ray forming the X-ray beams,
wherein the detector is so arranged that irradiation by each of the X-ray beams is provided over the two pixels of the detector.

2. The X-ray apparatus according to claim 1, wherein
the two pixels each have a region that is not provided with the absorbing element, and
the detector is so arranged that each of the X-ray beams the region not provided with the absorbing element in each of the two pixels.

3. The X-ray apparatus according to claim 1, wherein respective centers of the absorbing elements are arranged at respective centers of the intensities of the X-ray beams.

4. The X-ray apparatus according to claim 1, further comprising an arithmetic unit configured to acquire phase information of the detection object by using the intensity of the X-ray of the X-ray beam detected at the two pixels of the detector.

5. The X-ray detector according to claim 4, wherein the arithmetic unit acquires a position change amount of the X-ray beam by using intensity ratios of the X-ray beam detected at the two pixels.

6. The X-ray apparatus according to claim 1, wherein each of the absorbing elements is rectangular.

7. The X-ray apparatus according to claim 1, wherein each of the absorbing elements is cylindrical.

8. The X-ray apparatus according to any of claim 1, wherein each of the absorbing elements is conical.

9. The X-ray apparatus according to claim 6, further comprising a splitting element configured to spatially split an X-ray from an X-ray generator and form the plurality of X-ray beams, wherein the splitting element is formed of a slit array.

10. The X-ray apparatus according to claim 7, further comprising a splitting element configured to spatially split an X-ray from an X-ray generator and form the plurality of X-ray beams, wherein the splitting element is formed of a pin-hole array.

11. The X-ray apparatus according to any of claim 1, wherein the absorbing elements are embedded in an X-ray conversion member of the detector.

12. The X-ray apparatus according to claim 1, wherein the arithmetic unit acquires absorption information of the detection object through a calculation by using the intensity of the X-ray of the X-ray beam detected at the two pixels of the detector.

13. An X-ray measurement method, comprising:
detecting an intensity of a single X-ray beam which has passed through a detection object by a detector including at least two pixels; and
acquiring a phase contrast image of the detection object through a calculation, by using intensities of the X-ray detected at two pixels of the detector,
wherein part of the single X-ray beam is absorbed by an absorbing element arranged between the two pixels of the detector, and the single X-ray beam is provided over the two pixels of the detector.

14. The X-ray apparatus according to claim 1, further comprising a splitting element configured to spatially split an X-ray from an X-ray generator and form the plurality of X-ray beams.

15. The X-ray apparatus according to claim 8, further comprising a splitting element configured to spatially split an X-ray from an X-ray generator and form the plurality of X-ray beams, wherein the splitting element is formed of a pin-hole array.

16. An X-ray apparatus, comprising:
a detector configured to receive a single X-ray beam incident thereon and detect an intensity of the single X-ray beam which has passed through a detection object, the detector including a plurality of pixels; and
an absorbing element arranged at a boundary of two pixels from among the plurality of pixels included in the detector and configured to absorb part of the X-ray forming the single X-ray beam,
wherein the detector is so arranged that irradiation by the single X-ray beam is provided over the two pixels of the detector.

17. The X-ray apparatus according to claim 16, wherein the two pixels each has a region that is not provided with the absorbing element, and the detector is so arranged that the single X-ray beam irradiates a region that is provided with the absorbing element and the region not provided with the absorbing element in each of the two pixels.

18. The X-ray apparatus according to claim 17. Wherein a center of the absorbing element is arranged at a center of the intensity of the single X-ray beam.

19. The X-ray apparatus according to claim 17, further comprising a splitting element configured to form the single X-ray beam.
